(19) United States
(12) Patent Application Publication
(10) Pub. No.: US 2014/0220310 A1
(43) Pub. Date: Aug. 7, 2014

(54) GLASS FILM HAVING A DEFINED EDGE CONFIGURATION

(71) Applicant: SCHOTT AG, Mainz (DE)

(72) Inventors: Jürgen Vogt, Oberheimbach (DE); Thomas Wiegel, Alfeld (DE); Holger Wegener, Alfeld (DE); Ulrich Neuhäusler, Diedorf (DE); Angelika Ullmann, Coppenbrugge (DE)

(73) Assignee: SCHOTT AG, Mainz (DE)

(21) Appl. No.: 14/246,578

(22) Filed: Apr. 7, 2014

Related U.S. Application Data
(63) Continuation of application No. PCT/EP2012/004170, filed on Oct. 5, 2012.

(30) Foreign Application Priority Data
Oct. 7, 2011 (DE) 10 2011 084 131.8

(51) Int. Cl. C03C 17/32

(52) U.S. Cl. CPC C03C 17/32; C03C 17/326; C03C 2217/78; C03C 2218/11; C03C 2218/32
USPC 428/194; 427/372.2; 427/508

(57) ABSTRACT

A glass film has a thickness of less than 1.2 mm, and a first and a second surface, both surfaces being defined by edges having an edge surface. The respective edge surfaces are provided with a microstructure surface, including micro-cracks and fissures which are laterally defined by flanks. At least two edges located opposite one another include a low viscosity adhesive having a viscosity of less than 600 mPas at 23° C., on their microstructure surfaces in such a way that the respective flanks of the micro-cracks and fissures are bonded together using an adhesive so that the probability of failure of the glass film having a length of 1000 m and a thickness in the range of 5 μm to 350 μm, and a diameter of a wound glass film roll in the range of 50 mm to 1000 mm is less than 1%.

### CROSS REFERENCE TO RELATED APPLICATIONS

This is a continuation of PCT Application No. PCT/EP2012/004170, entitled “GLASS FILM HAVING A SPECIALLY DESIGNED EDGE”, filed Oct. 5, 2012, which is incorporated herein by reference.

### BACKGROUND OF THE INVENTION

1. Field of the Invention

The present invention relates to a glass film having a defined edge configuration, at whose edge surface the respective flanks of the micro-cracks and fissures are bonded together.

2. Description of the Related Art

For greatly diverse applications, such as for example in the field of consumer electronics, for example as glass covers, for organic light-emitting diode (OLED) light sources or for thin or curved display devices, or in the field or regenerative energies or energy technology, such as solar cells, thin glass is increasing used. Examples for this are touch panels, capacitors, thin film batteries, flexible circuit boards, flexible OLED's, flexible photo-voltaic modules or also e-papers. Thin glass is moving into focus more and more for many applications due to its excellent characteristics such as resistance to chemicals, temperature changes and heat, gas tightness, high electric insulation properties, customized coefficient of expansion, flexibility, high optical quality and light transparency and also high surface quality with very low roughness due to a fire-polished surface of the two thin glass entities. Thin glass is herein to be understood to be glass films having thicknesses of less than approximately 1.2 mm to thicknesses of 5 μm and smaller. Due to its flexibility, thin glass in the embodiment of a glass film is increasingly wound after production and stored as a glass roll, or transported for cutting to size and further processing. After an intermediate treatment, for example coating or cutting to size, the glass film can again be wound in a roll-to roll process and supplied to an additional application. Compared to storing and transporting flat material, winding of the glass includes the advantage of a more cost effective, compact storage, transport and handling during further processing. In further processing smaller glass film segments are separated from the glass roll or from material which is stored and transported flat according to the requirements. In some applications these glass film segments are again utilized as bent or rolled glass.

With all of the excellent characteristics, glass as a brittle material generally possesses a lower breaking resistance since it is less resistant against stress. When bending, the glass stresses occur on the outer surface of the bent glass. For breakage-free storing and breakage-free transport of such a glass roll or for crack-free and breakage-free utilization of smaller glass film segments the quality and integrity of the edges are of importance in the first instance, in order to avoid a crack or breakage in the wound or curved glass roll. Even damage to the edges such as minute cracks, for example micro-cracks, can become the cause and the point of origin for larger cracks or breakages in the glass film. Moreover, because of the tension on the top side of the wound or curved glass film, integrity and freedom of the surface from scratches, grooves and other surface defects is important in order to avoid the development of a crack or break in the wound or curved glass film. Thirdly, manufacture related interior stresses in the glass should be as small as possible or nonexistent in order to avoid development of a crack or break in the wound or curved glass film. In particular, the quality of the glass film edge is of particular importance in regard to crack formation or crack propagation into a break of the glass film.

According to the current state of the art thin glasses or glass films are mechanically scored and broken with a specially ground diamond or a small wheel of special steel or tungsten carbide. Scoring the surface produces a targeted stress in the glass. Along the thus produced fissure the glass is broken, controlled by pressure, tension or bending. This causes edges having severe roughness, many micro-cracks and popping and conchoidal ruptures at the edges.

In order to increase edge strength these edges are subsequently usually edged, beveled or polished. Mechanical edge processing is no longer realizable for glass films, in particular at thicknesses less than 200 μm without causing additional cracking or breakage risks for the glass.

In order to achieve better edge quality the laser scribing process according to the current state of the art is applied in order to break a glass substrate by means of a thermally generated mechanical tension. A combination of both methods is also known and used in the current state of the art. In the laser scribing method the glass is heated along a precisely defined line with a bundled laser beam, usually a CO₂ laser beam and a thermal tension is produced in the glass by an immediately following cold jet of cooling fluid such as compressed air or an air-fluid mixture that is great enough that the glass is breakable or breaks along the predefined edge. A laser scribing method of this type is described, for example, in International Patent Publication Nos. DE 693 04 194 T2 and EP 0 872 303 B1 and U.S. Pat. No. 6,407,360.

However, this method also produces a broken edge with corresponding roughness and micro-cracks. Originating from the indentations and micro-cracks in the edge structure, tears can form and spread in the glass in particular when bending or winding a thin glass film in a thickness range of less than 200 ?m, which eventually lead to a break in the glass.

A suggestion is made in International Publication No. WO 99/46212 for increasing the edge strength. It is suggested to coat a glass sheet edge and fill micro-cracks originating from the glass edge with a highly viscous curable synthetic material. The coating can be applied by dipping of the glass edge into the synthetic material and curing with ultra-violet (UV) light. Protruding synthetic material on the outside surface of the glass sheet is subsequently removed. This method is suggested for glass sheets of 0.1 to 2 mm thickness. Herein it is disadvantageous that it includes several expensive additional process steps and that it is rather unsuitable for glass films in the range of 5 to 200 μm. In particular, on such thin glass films protruding synthetic material cannot be removed without damaging the film. Moreover, coating of the glass edge and even filling of the micro-cracks as disclosed in International Publication No. WO 99/46212 prevents crack formation and spreading of cracks only to a limited extent. A highly viscous synthetic material as is suggested therein can only cover micro-cracks in the surface structure of the glass sheet edge superficially due to its viscosity. Accordingly tension micro-cracks can therefore still act as point of origin for spreading of cracks which then leads to breaking of the glass sheet.

To increase the edge strength of glass substrates in the thickness range of greater than 0.6 mm or respectively greater than 0.1 mm, International Patent Application Publication No. WO 2010/135614 suggests surface coating of the edges with a polymer. The thickness of the coating should be in the range of 5 to 50 μm. However, here too such a coating prevents formation and spreading of cracks originating from the edge only to a limited extent as is explained in the document, since micro-cracks in the edge surface structure can lead unhindered from its depth to crack growth. Moreover, a coating process of this type of an edge with synthetic material on thin glass films in the range of 200 to 5 μm can only be implemented at great expense. Moreover it cannot be avoided, in particular with very thin films, that the coating at the edge forms thickenings which cannot be removed without the risk of damaging the film and which represent a great impairment during use or during winding of the glass film. The glass film edges which are thickened by a synthetic material coating would lead to bending of the glass film during winding and would prevent compact winding of the glass film. This would result in stresses and possibly to oscillation or vibration of partial regions, for example during transport of the glass film in the embodiment of the glass roll, which represents an enormous risk of breakage for the glass roll.

For the repair of hairline cracks in glass sheets it is known from International Patent No. GB 1,468,802 to apply a mixture consisting of:
poly-epoxide with a curing agent; and
an unsaturated polyester resin, a thinner, a polymerization catalyst and at least one polymerization accelerator,
   onto the glass surface above the crack in such a way that the mixture penetrates into the hairline crack, fills it and polymerizes in the hairline crack, so that it becomes sealed. In International Patent No. GB 1,468,802 the maximum viscosity of the descripted mixture is specified as a viscosity of 1000 centiPoise (cP) (1000 mPas). In order to fill the hairline cracks values of 0.65 cp (0.65 milliPascal (mPas)) are given as the lower limits at which the hairline cracks are still being filled. International Patent No. GB 1,468,802 describes only the repair of damages on glass sheets and not on thin glass films and also specifically not that the edge strength is increased through gluing.

It was moreover disadvantageous with the described mixtures in International Patent No. GB 1,468,802 for sealing of hairline cracks on glass surfaces that the curing occurred with the assistance of polymerization compositions. Rapid sealing of the hairline cracks was not possible with such compositions.

What is needed in the art is a glass film which avoids the disadvantages of the current state of the art and which in particular has sufficient edge quality which will permit bending or rolling of the glass film wherein formation of a crack originating from the edge is largely or completely avoided. In particular, the edge strength is to be increased by such a measure, so that the probability of failure when winding a glass film ribbon having a thickness in the range of 5 μm to 350 μm, for example 15 μm to 200 μm into a roll having a roll diameter in the range of 50 mm to 1000 mm, for example 150 mm to 600 mm at a length of 1000 mm is less than 1%.

### SUMMARY OF THE INVENTION

The present invention provides a glass film having a first surface and a second surface which are both defined by like edges. The surface of the edges has a microstructure having a microstructure surface. The edge surfaces include micro-cracks and fissures at least partially in their microstructure surface. In particular when stresses act upon the micro-cracks and fissures they may act as point of origination for a crack formation and crack advancement into the glass film which causes the glass film to be defunct or results in breakage of the glass film. Such stresses can be caused by tensions, for example, during bending or winding of the glass film or through oscillations or vibrations.

These micro-cracks and fissures have respective lateral flanks in orientation perpendicular to the edge surface which, in the case of a crack advancement, open up opposite relative to one another. According to the present invention the respective flanks of the micro-cracks and fissures are bonded together using a glass adhesive at least on two edges located opposite each other on their edge surfaces.

This adhesion prevents that the flanks can open up relative to one another, thereby effectively preventing crack formation and crack advancement.

Bonding is not a coating of the edge surface, but a bonding of the micro-crack flanks and the flanks of fissures in the region of the microstructure of the edge surface. As a result the edge surface after bonding of the respective flanks of the micro-cracks and fissures is consistent in its height with the thickness of the glass film. An undesirable thickness on the glass film edge or a protrusion of the bonding over the first or second surface of the glass film is largely eliminated. A thickening of this type is especially undesirable when winding the glass film, since it leads to bending of the glass film in a lateral direction of the roll due to the created gap between the edges, which in turn can lead to oscillation of the glass film in the glass roll and to damage and breaking of the film.

The at least two edges located opposite one another are to be understood to be in particular edges which are bent during bending or winding of the glass film. In addition however, one or both edges progressing perpendicular to the bending radius can be of the inventive configuration.

For bonding the flanks of the micro-cracks and fissures in the surface structure of the glass film edges all adhesives are basically suitable which possess a sufficient adhesion on glass and have sufficiently low viscosity that they can completely penetrate into the micro-cracks. The penetration is herein supported by the capillary action of the crack gap of the micro-cracks.

According to the present invention low viscosity adhesives, especially acrylates, such as modified acrylates are utilized as adhesives, for example UV-curing acrylates, in other words acrylate adhesives which are radically cured with the assistance of ultraviolet radiation, cyan-acrylates or also urethane-acrylates. Furthermore, epoxy resins are feasible, for example those with low viscosity additives, for example glycidyl ether. Exemplary epoxy resins further include are modified epoxy resins and UV-curing epoxy resins. Cationic resins are suitable as UV-curing epoxy resins. For the inventively utilized adhesives, viscosities are selected in the range of between approximately 0.5 and 600 mPas at 23° C., for example in a range between 0.5 and 250 mPas at 23° C., in a range between 1 and 150 mPas at 23° C., or in a range between 1 and 80 mPas at 23° C.

Suitable adhesives are those which are cured with ultraviolet light, such as UV-acrylates or UV-curing epoxy resins since here a very short curing time and thereby rapid further processing can be ensured.

For example, a low viscosity UV-curing, single component solvent-free epoxy resin having a viscosity of less than 600 mPas at 23° C., for example DELO-Katiobond® AD610 by DELO Industrial Adhesives, DELO-Allee 1, 86949 Windach, Germany is used.

Adhesives on an acrylate basis which are UV-curing surprisingly display especially good processability. Such adhesives are characterized by very low viscosities of less than 120 mPas as well as curing times of less than 1 hour (h), for example less than 10 minutes, or less than 1 minute. An example is DELO-Photobond GB 310 or DEO-Lotus 2 by DELO Industrial Adhesives, DELO-Allee 1, 86949 Windach, Germany. According to the present invention the adhesion provides that the probability of failure, that is the probability that the glass ribbon or respectively the glass film breaks, when evaluating a plurality of glass films having a length of 1000 meters (m) and a thickness in the range of 5 micrometers (μm) to 1.2 mm, such as 5 μm to 350 μm or 15 μm to 200 μm when winding onto a roll having a roll diameter in the range of 50 millimeters (mm) to 1000 mm, for example 150 mm to 600 mm, is less than 1%.

In an additional embodiment of the present invention the first and the second surface of the glass film, in other words the two surfaces of the glass film, can also have a fire-polished surface. In this embodiment the glass surfaces have a root mean square average (RMS) Rq of not exceeding 1 nanometer, for example not exceeding 0.8 nanometer, or not exceeding 0.5 nanometer, measured over a length of 670 μm. Moreover the average surface roughness (Ra) of their surfaces is a maximum of 2 nanometers, for example a maximum of 1.5 nanometer (nm), or a maximum 1 nanometer measured over a length of 670 μm.

In a further embodiment a glass film according to the present invention has a thickness of a maximum of 200 μm, for example a maximum of 100 μm, a maximum of 50 μm, or a maximum of 30 μm and at least 5 μm, for example at least 10 μm, or at least 15 μm and can be bent and wound in spite of the brittleness of glass without the risk of cracking or breaking.

In one embodiment one such inventive glass film has an alkaline oxide content not exceeding 2 weight-%, for example not exceeding 1 weight-%, not exceeding 0.5 weight-%, not exceeding 0.05 weight-%, or not exceeding 0.03 weight-%.

In one additional embodiment one such inventive glass film consists of a glass which contains the following components (in weight-% on oxide basis):

| | |
|---|---|
| SiO₂ | 40-75; |
| Al₂O₃ | 1-25; |
| B₂O₃ | 0-16; |
| Alkaline earth oxide | 0-30; and |
| Alkaline oxide | 0-2. |

In one additional embodiment one such inventive glass film consists of a glass which contains the following components (in weight-% on oxide basis):

| | |
|---|---|
| SiO₂ | 45-70; |
| Al₂O₃ | 5-25; |
| B₂O₃ | 1-16; |
| Alkaline earth oxide | 1-30; and |
| Alkaline oxide | 0-1. |

Especially suitable glass films can hereby be produced.

The present invention moreover includes a method to produce a glass film which possesses sufficient edge quality that permits bending or winding of the glass film, wherein formation of a crack originating from the edge is reduced or eliminated.

According to the present invention a glass film is provided and the edge surface of at least two edges located opposite one another are moistened with a low viscosity adhesive and the adhesive is subsequently cured.

Such a glass film is produced from a molten glass, for example glass having low alkaline content in the down-draw method or in the overflow-downdraw-fusion method. It has been shown that both methods which are generally known in the current state of the art (compare for example International Publication No. WO 02/051757 A2 for the down-draw-method and International Publication No. WO 03/051783 A1 for the overflow-downdraw-fusion method) are especially suitable for drawing thin glass films having a thickness of less than 200 μm, for example less than 100 μm, or less than 50 μm and having a thickness of at least 5 μm, for example at least 10 μm, or at least 15 μm.

In the down-draw-method which is described in principle in International Publication No. WO 02/051757 A2, bubble-free and well homogenized glass flows into a glass reservoir, the so-called drawing tank. The drawing tank consists of precious metals, including platinum or platinum alloys. Arranged below the drawing tank is a nozzle device, including a slotted nozzle. The size and shape of this slotted nozzle defines the flow of the drawn glass film, as well as the thickness distribution across the width of the glass film. The glass film is drawn downward by use of draw rollers and eventually arrives in an annealing furnace which is located following the draw rollers. The annealing furnace slowly cools the glass down to near room temperature in order to avoid stresses in the glass. The speed of the draw rollers defines the thickness of the glass film. After the drawing process the glass is bent from the vertical into a horizontal position for further processing.

After drawing the glass film has a fire-polished lower and upper surface in its two-dimensional expansion. “Fire-polished” means that the glass surface during solidification of the glass during thermal molding only forms through the boundary surface to the air and is not subsequently altered either mechanically or chemically. The area of the thus produced thin glass has thereby no contact during thermal molding with other solid or liquid materials. Both aforementioned glass drawing methods result in glass surfaces having a root mean square average (RMS) Rq of not exceeding 1 nanometer, for example not exceeding 0.8 nanometer, or not exceeding 0.5 nanometer, typically in the range of 0.2 to 0.4 nanometer and a surface roughness Ra not exceeding 2 nanometers, for example not exceeding 1.5 nanometer, not exceeding 1 nanometer and typically in a range between 0.5 and 1.5 nanometer, measured over a length of 670 μm.

Located at the edges of the drawn glass film are process related thickenings, so-called laces on which the glass is pulled from the draw tank and guided. In order to be able to wind and bend the glass film in a volume-saving manner and also to a small diameter, it is advantageous or necessary to detach these laces. For this purpose a stress is created along a predefined breaking line using mechanical scoring and/or a treatment with a laser beam with subsequent targeted cooling, wherein the glass is subsequently broken along this break line. The glass film is then stored flat or on a roll and transported.

The glass film can also be cut into smaller segments or sizes in a downstream process. In this case too, a stress is created prior to breaking the glass along a predefined breaking line, either using mechanical scoring or treatment with a laser beam with subsequent targeted cooling, or through a combination of both methods. In each case a rough edge with micro-cracks and fissures occurs due to the breakage and these may act as a point of origination for the formation and advancement or widening of a micro-crack into a crack in the glass film.

According to the present invention the microstructure surface of the edge surface of this fractured edge is moistened with an adhesive, so that the flanks of the micro-cracks and fissures bond together. A micro-crack is hereby understood to be a crack which leads from the edge surface into the glass material. Fissures are located in the region of the roughness and have relatively steep flanks with a relatively pointed base point between the flanks. We are not talking about a coating of the edge surface with a synthetic material or polymer, but about a measure in the region of the microstructure. For this purpose the adhesive must have an accordingly low viscous consistency. The viscosity of the adhesive is in the region of 0.5 to 600 milliPascals (mPas), for example in a range between 0.5 and 250 mPas, between 1 and 150 mPas, or between 1 to 80 mPas.

According to the present invention because of this low viscosity no undesirable thicknesses form on the glass film due to protruding adhesive. This insures in particular compact winding of the glass film onto a roll, whereby full surface contact between the glass film layers is ensured.

Basically all adhesives which have sufficient adhesion on glass and which have such low viscosity that they can penetrate in particular into the micro-cracks are suitable for bonding.

Penetration is hereby supported by the capillary effect of the crevices of the micro-cracks. Suitable adhesives are acrylates, for example UV-cured acrylates, in other words acrylate adhesives which are radically cured with the assistance of ultraviolet radiation, urethane-acrylates or also cyanoacrylates. Furthermore, epoxy resins are suitable, for example those with low viscosity additives, for example glycidyl ether. Cationic resins are feasible as UV-curing epoxy resins.

In one embodiment of the present invention, curing of the appropriate adhesive is provided for with the assistance of ultraviolet radiation. The radiation source can be a UV-tube, whereby the UV-tube and the microstructure of the glass film edge are moved relative to one another. The UV-light spectrum is coordinated with the respective adhesive and the tube or respectively the UV-light source is positioned in such a way that it radiates into the entire height of the edge surface over a certain length of the glass film.

In another embodiment of the present invention a thermal treatment is utilized for curing of the appropriate adhesive. The energy input into the microstructure surface of the glass film edge occurs for example through hot air or heat radiation, such as infrared radiation.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates a right and a left section of a glass film according to the present invention as a segment from a 1000 mm long glass film ribbon with two edges located opposite one another; and

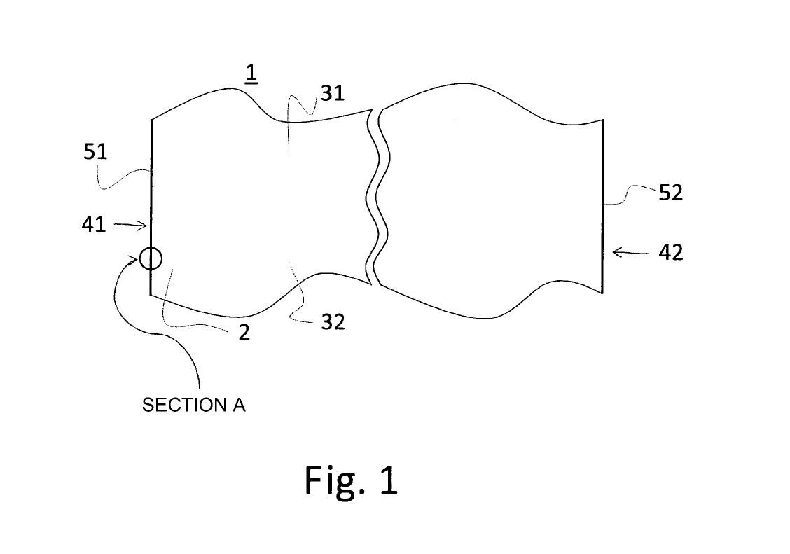

FIG. 2 illustrates the enlargement of a segment from an edge of the glass film illustrated in FIG. 1.

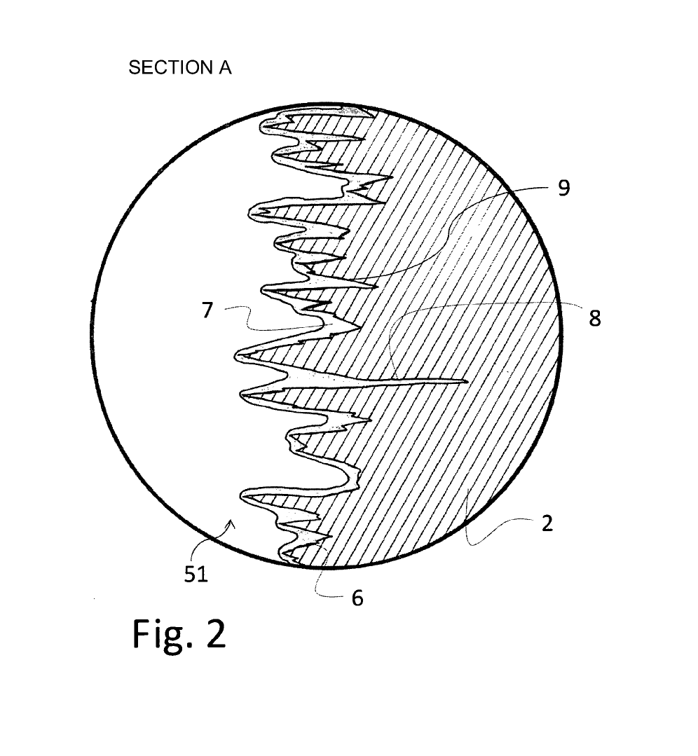

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

Referring now to the drawings, there is shown a 1000 mm long glass film, for example from glass AF32, or AF32eco by SCHOTT AG, Mainz, having a width of 500 mm and a thickness of 50 μm, which was drawn in the down-draw method and wound onto a glass roll. Prior to winding, the laces on the glass film were removed with the laser scribe method, so that edges 41, 42 are formed along the glass film in a draw direction. Microstructure surface 6 of edges 41, 42 was marked strongly by fissures and micro-cracks. In the 2-point bending test, the strength of the edges was an average of 400 MPa (megapascal)±350 MPa. This means that because of the micro-cracks and fissures there is a very high scattering of the edge strength, so that the probability of a breakage of the glass film during winding onto and unwinding from the glass roll is very high.

Subsequent to separating the laces using the laser scribe method, edge surfaces 51, 52 were moistened with an acrylate UV-adhesive Conloc UV 665 by EGO Dichtstoffwerke GmbH & Co. Betriebs KG., so that the adhesive could cover microstructure 6 of edges 41, 42 with a coating. Adhesive 7 had a viscosity of 50 mPAs (millipascal seconds) and, supported by the capillary effect of the fine micro-cracks 8, could penetrate into same. Adhesive 7 moistened the flanks of micro-cracks 8 and fissures 9. Due to its surface tension, adhesive 7 filled the micro-cracks and the narrow valley regions of the fissures and respectively bonded the flanks after it cured. No masking of the edge surface 51, 52 materialized, only masking of microstructure surface 6.

The edges of the glass film were subsequently radiated using an OVA-radiator UVAHAND 250 by the Dr. Hönle AG., Gräfeling, Munich for photochemical polymerization of adhesive 7. The UVA-radiator had an output of 250 Watts (W).

As an alternative hereto the micro-cracks on the edge surface of a glass film as described above can also be sealed with an acrylate adhesive DELO Photobond GB310 by immersion into the adhesive due to its surface tension. For this purpose the low viscosity adhesive, having a viscosity of 100 mPas, is cured after application through the effect of UV-radiation in the wavelength range of 320-400 nm for 1 minute using a UV-lamp, type UVH FZ-2020.

After bonding of the flanks of micro-cracks 8 and fissures 9, the edge strength displayed a clear scattering of ±50 mPA. The glass film could be wound without the risk of breakage.

Table 1 specifies the edge strengths for various glass films AF32eco, D263Teco, MEMpax, in other words the tensions in MPa which are created during winding of a glass film with a roll radius:

TABLE 1

Diameter
[mm]

| | | | | |
|---|---|---|---|---|
| 75 | 175 | 250 | 375 | 500 |

AF32 eco

| E-Modulus | 74.8 | | | | | |
|---|---|---|---|---|---|---|
| Glass thickness | 20 | 20 | 9 | 6 | 4 | 3 |
| [μm] | 50 | 50 | 21 | 15 | 10 | 7 |
| | 70 | 70 | 30 | 21 | 14 | 10 |
| | 100 | 100 | 43 | 30 | 20 | 15 |
| | 150 | 150 | 64 | 45 | 30 | 22 |
| | 200 | 199 | 85 | 60 | 40 | 30 |

D263 T eco

| | | | | | | |
|---|---|---|---|---|---|---|
| E-Modulus | 72.9 | | | | | |
| Glass thickness | 20 | 19 | 8 | 6 | 4 | 3 |
| [μm] | 50 | 49 | 21 | 15 | 10 | 7 |
| | 70 | 68 | 29 | 20 | 14 | 10 |
| | 100 | 97 | 42 | 29 | 19 | 15 |
| | 150 | 146 | 62 | 44 | 29 | 22 |
| | 200 | 194 | 83 | 58 | 39 | 29 |

MEMpax

| | | | | | | |
|---|---|---|---|---|---|---|
| E-Modulus | 62.7 | | | | | |
| Glass thickness | 20 | 17 | 7 | 5 | 3 | 3 |
| [μm] | 50 | 42 | 18 | 13 | 8 | 6 |
| | 70 | 59 | 25 | 18 | 12 | 9 |
| | 100 | 84 | 36 | 25 | 17 | 13 |
| | 150 | 125 | 54 | 38 | 25 | 19 |
| | 200 | 167 | 72 | 50 | 33 | 25 |

These are the AF32eco, D263Teco and MEMpax glasses by SCHOTT AG., Mainz. Tension σ in MPa is specified in dependency on the glass thickness (d) in μm, as well as dependency on diameter (D) in mm of the wound glass roll. The formula for determining the edge strength, in other words the tension on the outside of the glass ribbon, is calculated as follows.

σ=E·y/r

Whereby E is the elasticity modulus (E-modulus), y is half the glass thickness (d/2) of the glass ribbon which is to be wound and r=D/2 is the wound radius of the wound glass ribbon.

With the values for σ from Table 1 and the knowledge of the probability of failure for a multitude of tests which are analyzed, the probability of failure P for a glass ribbon having a certain length and roll radius can be determined. The probability of failure represents a Weibull-distribution whose width is characterized by the Weibull-parameter.

The Weibull-distribution is a continuous probability distribution over the cumulative positive real numbers which are used to describe lifespans and rate of failure of brittle materials such as glasses. The Weibull-distribution can be used to describe failure rates of technical systems. The Weibull-distribution is characterized by the broadness of the distribution, the so-called Weibull-modulus. It generally applies that the larger the modulus, the narrower the distribution.

If one conducts 2-point bending measurements with test lengths of 50 mm, the probability of failure of glass ribbons having a length (L) can be determined as follows with the knowledge of the Weibull-modulus:

$$P ( L , r ) = 1 - exp ( - \frac{L}{l} {( \frac{σ ( r )}{μ} )}^{β} )$$

(P) is the probability of failure of the glass ribbon having a length (L) and at a roll radius (r); (L) is the length of the glass ribbon for which the probability or failure is determined;

(l) is the relevant test length which is used in the 2-point test, for example l=50 mm.
ó (r) is the tension which occurs through winding with roll radius (r),
μ is the tension β determined in the 2-point bending test in the Weibull-modulus which describes the width of the distribution and thereby the extensions to small strength properties.

The predetermination of the probability of failure makes it possible that, if one wishes to wind a glass ribbon having thickness (d) to a radius (r), and having a winding length of 1000 m and wishes to achieve a probability of failure of 1% (or less) and if the relevant test length of the 2-point measurement is 50 mm to establish the following condition:

$$- 14.5 < β \cdot ln ( \frac{σ ( r )}{μ} )$$

If one assumes σ(r) for the tension from Table 1, then the following results for parameter α that characterizes the system and which is also defined as “figure of merit”:

$$α = β \cdot ln ( \frac{σ ( r )}{μ} )$$

Value α is, for example, increased with the assistance of the inventive measures, for example from 12 to 14.5 due to the increase of the edge strength.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMBERS

| | |
|---|---|
| (1) | Glass film |
| (2) | Glass |
| (31, 32) | First and second surface of the glass film |
| (41, 42) | Edges of the glass film |
| (51, 52) | Edge surfaces of the glass film |
| (6) | Microstructure surface of the edge |
| (7) | Adhesive |
| (8) | Micro-crack |
| (9) | Fissure |

What is claimed is:

1. A glass film having a thickness of less than 1.2 millimeter (mm), comprising a first surface and a second surface, each of said first surface and said second surface being defined by a plurality of edges, each of said edges having a respective edge surface including a microstructure surface having a plurality of micro-cracks and fissures laterally defined by a plurality of flanks, at least two of said plurality of edges located opposite one another including a low viscosity adhesive having a viscosity of less than approximately 600 milliPascals (mPas) at 23° C. on said respective microstructure surface of each of said at least two edges such that said flanks of said micro-cracks and fissures are bonded together with said adhesive so that a probability of failure of the glass film having a length of 1000 meters (m), a thickness in a range of between approximately 5 micrometers (μm) and 350 μm, and a diameter of a roll of the glass film in a range of between approximately 50 mm and 1000 mm, is less than 1%.

2. The glass film according to claim 1, said viscosity of said low viscosity adhesive being less than 150 mPas at 23° C. on said microstructure surfaces.

3. The glass film according to claim 2, said viscosity of said low viscosity adhesive being in a range of between 25 mPas and 80 mPas at 23° C.

4. The glass film according to claim 1, wherein said at least two opposing edge surfaces having said bonded flanks of said microcracks and said fissures have a height substantially consistent with said thickness of said glass film.

5. The glass film according to claim 1, wherein said adhesive is an acrylate.

6. The glass film according to claim 5, wherein said acrylate is a modified acrylate.

7. The glass film according to claim 1, wherein said adhesive is an epoxy resin.

8. The glass film according to claim 1, wherein said first surface and said second surface of the glass film are fire-polished surfaces.

9. The glass film according to claim 1, wherein said thickness of the glass film is a maximum of 200 μm.

10. The glass film according to claim 1, wherein said thickness of the glass film is at least 5 μm.

11. The glass film according to claim 1, wherein the glass film has an alkaline oxide content not exceeding 2 weight percent (%).

12. The glass film according to claim 1, wherein the glass film is formed by a glass including (in weight % on an oxide basis):

| | |
|---|---|
| SiO₂ | 40-75; |
| Al₂O₃ | 1-25; |
| B₂O₃ | 0-16; |
| Alkaline earth oxide | 0-30; and |
| Alkaline oxide | 0-2. |

13. The glass film according to claim 1, wherein the glass film is formed by a glass including (in weight % on an oxide basis):

| | |
|---|---|
| SiO₂ | 45-70; |
| Al₂O₃ | 5-25; |
| B₂O₃ | 1-16; |
| Alkaline earth oxide | 1-30; and |
| Alkaline oxide | 0-1. |

14. A method of producing a glass film, the method comprising the steps of:
providing a glass film having a thickness of less than 1.2 millimeter (mm);
wetting a microstructure surface of an edge surface of at least two opposing edges of the glass film with a low viscosity adhesive having a viscosity of less than 600 milliPascals (mPas) at 23° C.;
curing said adhesive to form the glass film such that a probability of failure of the glass film with a length of 1000 meters (m), a thickness in the range of between approximately 5 μm and 350 μm, and a diameter of a wound glass roll of the glass film in a range of between approximately 50 mm and 1000 mm is less than 1%.

15. The method according to claim 14, wherein prior to said wetting step, the method further comprises the steps of:
creating a stress in the glass film using at least one of mechanical scoring and treatment with a laser beam with a subsequent targeted cooling along a predefined breaking line; and
breaking the glass film along said breaking line.

16. The method according to claim 14, said adhesive having a viscosity in a range of between 0.5 and 600 mPas at 23° C.

17. The method according to claim 14, said adhesive being an acrylate.

18. The method according to claim 14, said adhesive being an epoxy resin.

19. The method according to claim 14, further comprising the step of using ultra-violet radiation for said curing step.

20. The method according to claim 14, further comprising the step of using a thermal treatment for said curing step.
